(19) United States
(12) Patent Application Publication
(10) Pub. No.: US 2018/0154701 A1
(43) Pub. Date: Jun. 7, 2018

(54) PNEUMATIC TIRE

(71) Applicant: TOYO TIRE & RUBBER CO., LTD., Itami-shi (JP)

(72) Inventor: Akinori Miyake, Itami-shi (JP)

(73) Assignee: TOYO TIRE & RUBBER CO., LTD., Itami-shi (JP)

(21) Appl. No.: 15/798,754

(22) Filed: Oct. 31, 2017

(30) Foreign Application Priority Data
Dec. 2, 2016 (JP) 2016-234734

(51) Int. Cl. B60C 11/13

(52) U.S. Cl. CPC B60C 11/1307; B60C 2011/0348; B60C 11/1323

(57) ABSTRACT

A pneumatic tire has a narrow groove which extends in a tire circumferential direction and is formed in a shoulder land portion of a tread. The shoulder land portion is sectioned into a main land portion in a tread center side and a sacrificed land portion in a tread end side by the narrow groove. A groove bottom portion of the narrow groove is formed by depressing a groove wall in the tread center side. A plurality of dimples obtained by depressing the groove wall of the narrow groove in the tread center side are provided between the groove bottom portion of the narrow groove and a tread end side edge of the main land portion.

### BACKGROUND OF THE INVENTION

### Field of the Invention

The present invention relates to a pneumatic tire in which a narrow groove extending in a tire circumferential direction is formed in a shoulder land portion of a tread.

### Description of the Related Art

As shown in FIG. 5, there has been known a pneumatic tire in which a narrow groove 73 extending in a tire circumferential direction is formed in a shoulder rib 70 (an example of the shoulder land portion) of the tread, and the pneumatic tire is disclosed, for example, in patent document 1. The shoulder rib 70 is sectioned into a main rib 71 in a tread center side and a sacrificed rib 72 in a tread end side by the narrow groove 73. In the tire structured as mentioned above, wear of the main rib 71 can be suppressed by concentrating the wear on the sacrificed rib 72. As a result, it is possible to improve an irregular wear resistance. The narrow groove 73 is also called as a defense groove, and is formed in a pneumatic tire for heavy load which is mainly used in a truck and a bus.

However, a ground pressure tends to become higher in a tread end side edge 71E of the main rib 71 even in the case that the narrow groove 73 is provided, a shoulder fall wear as shown by a broken line BL is generated due to the tendency. Therefore, a local irregular wear has been sometimes generated in the main rib 71. According to the knowledge of the inventor of the present invention, in order to prevent the shoulder fall wear in the main rib 71 as mentioned above, it is effective to form a groove bottom portion of the narrow groove 73 to be depressed to the tread center side as shown in FIG. 6, and decrease the ground pressure of the tread end side edge 71E. The shape of the groove bottom portion as mentioned above has been known as a method of suppressing a groove bottom crack of the narrow groove 73, for example, as disclosed in patent document 2.

FIG. 7 shows the tread in FIG. 6 at the cure molding time. In the cure molding, a main groove and a narrow groove 73 are formed by pressing a metal mold 90 having a bone portion 91 and a blade 92 as shown in the FIG. 7 to a ground surface of the tread. A leading end portion of the blade 92 corresponds to the groove bottom portion of the narrow groove 73, and is formed to bulge out to the tread center side. As a result, a resistance for pulling the blade 92 is great, and there has been room for improvement about a mold releasing performance, for example, the main rib 71 gets chipped and the blade 92 is broken when the blade 92 is pulled forcibly.

In a tire described in patent document 3, a plurality of dimples are formed in a groove wall in a tread center side of a narrow groove, however, the dimples are provided for uniformizing a ground pressure of a shoulder land portion, and does not show any solving means for the problem of pulling the blade as mentioned above. Further, in tires described in patent documents 4 and 5, an annular groove extending continuously in a tire circumferential direction is formed in a groove wall in a tread center side of a narrow groove, a leading end portion of the blade tends to catch on the annular groove along the tire circumferential direction at the mold releasing time. As a result, there is fear that the main rib disadvantageously fractures.

### PRIOR ART DOCUMENT

### Patent Document

Patent Document 1: JP-A-2013-147076

Patent Document 2: WO2008/111582

Patent Document 3: JP-A-2012-101741

Patent Document 4: JP-A-H11-301214

Patent Document 5: JP-A-H7-76204

### SUMMARY OF THE INVENTION

The present invention is made by taking into consideration the above actual condition, and an object of the present invention is to provide a pneumatic tire in which a narrow groove extending in a tire circumferential direction is formed in a shoulder land portion of a tread and which is excellent in an irregular wear resistance and a mold releasing performance at the cure molding time.

The present invention provides a pneumatic tire comprising a narrow groove which extends in a tire circumferential direction and is formed in a shoulder land portion of a tread, the shoulder land portion being sectioned into a main land portion in a tread center side and a sacrificed land portion in a tread end side by the narrow groove,

wherein a groove bottom portion of the narrow groove is formed by depressing a groove wall in the tread center side, and

wherein a plurality of dimples obtained by depressing the groove wall of the narrow groove in the tread center side are provided between the groove bottom portion of the narrow groove and a tread end side edge of the main land portion.

In this tire, since the groove bottom portion of the narrow groove is formed by depressing the groove wall in the tread center side, the ground pressure of the tread end side edge of the main land portion decreases. As a result, it is possible to suppress the local irregular wear by uniformizing the ground pressure of the main land portion, and the tire is excellent in the irregular wear resistance. Further, since a plurality of dimples obtained by depressing the groove wall in the tread center side are provided between the groove bottom portion of the narrow groove and the tread end side edge of the main land portion, the resistance for pulling the blade is small, and the tire is excellent in the mold releasing performance at the cure molding time.

It is preferable that a plurality of the dimples are arranged in a zigzag manner along a length direction of the narrow groove. According to the structure mentioned above, since the leading end portion of the blade does not catch on the dimples along the tire circumferential direction at the mold releasing time, an excellent mold releasing performance can be achieved.

It is preferable that each of the dimples and each of the different dimples in the nearest position are arranged so as not to overlap each other as seen from a depth direction and/or a length direction of the narrow groove. As a result, it is possible to suppress the rigidity reduction of the groove wall which is provided with the dimples and to prevent the rubber chip between the dimples due to the blade pulling.

It is preferable that each of the dimples is formed into a semi-droplet shape in a tire meridian cross section. According to the structure, since the protruding portion of the blade for forming the dimples tends to easily come off from the groove wall, the mold releasing performance is further improved as well as the rubber chip between the dimples can be prevented.

### BRIEF DESCRIPTION OF THE DRAWINGS

FIG. 1 is a cross sectional view of a tire meridian schematically showing one example of a tread of a pneumatic tire according to the present invention;

FIG. 2 is an enlarged view showing a substantial part of FIG. 1;

FIG. 3 is a perspective view showing a groove wall of a narrow groove in a tread center side;

FIGS. 4(a) and 4(b) are cross sectional views of dimples;

FIG. 5 is a cross sectional view showing a shoulder land portion of a conventional tire;

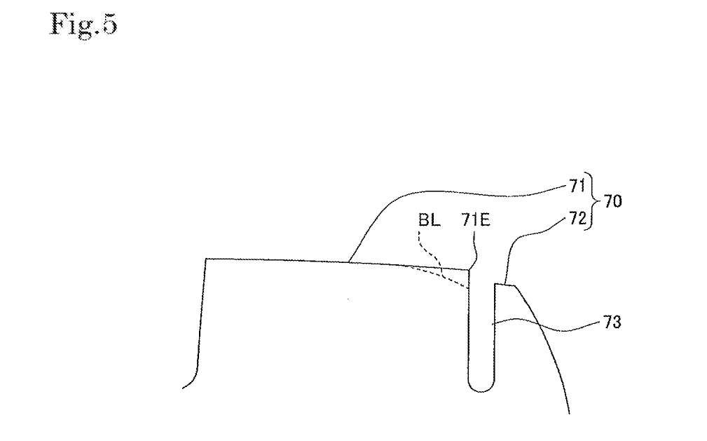

FIG. 6 is a cross sectional view showing a shoulder land portion of a conventional tire; and

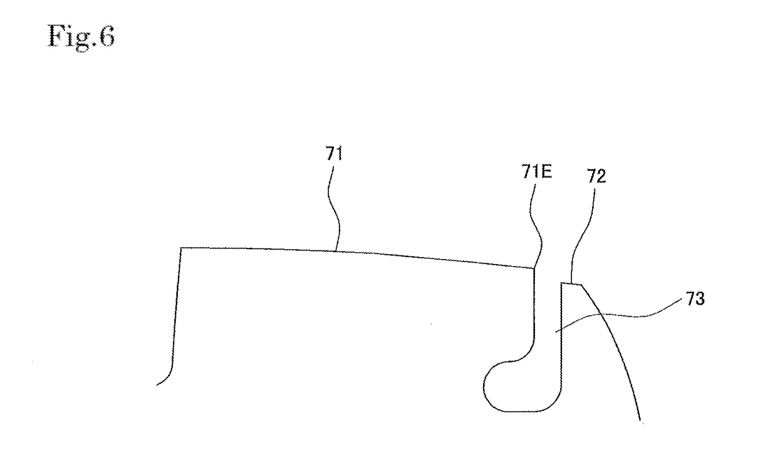

FIG. 7 is a cross sectional view showing a state of forming a tread in FIG. 6.

### DETAILED DESCRIPTION OF THE PREFERRED EMBODIMENTS

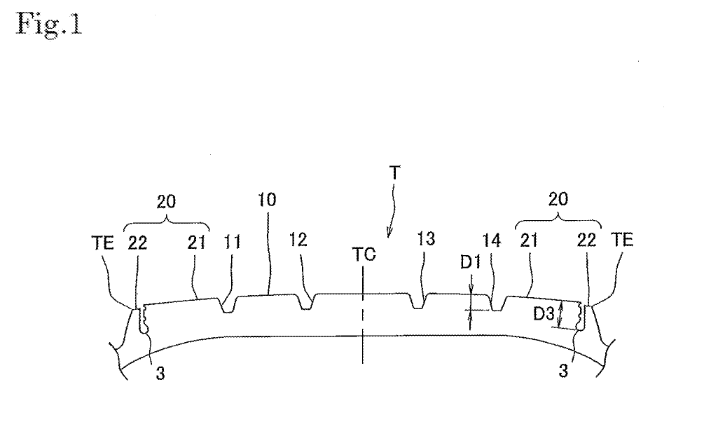

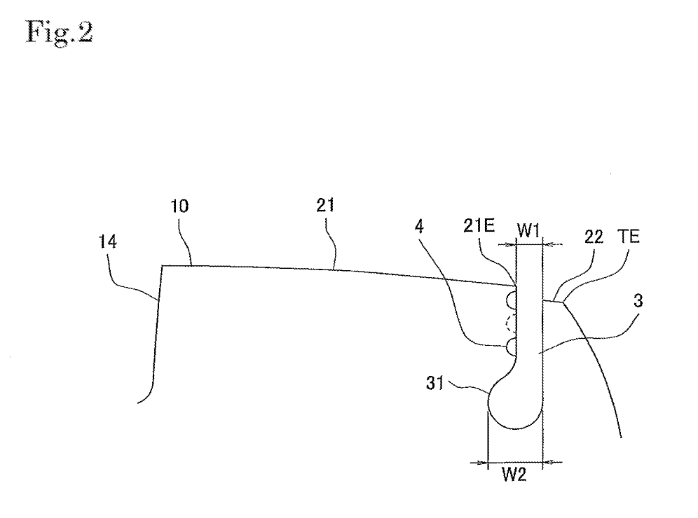

An embodiment of the present invention will be explained with reference to the drawings. FIG. 1 schematically shows a tread 10 of a pneumatic tire T according to the present embodiment, and FIG. 2 shows a substantial part of the tread 10 in an enlarged manner.

The pneumatic tire T has a pair of beads (not shown) and a pair of side walls which extend to an outer side in a tire radial direction from the beads, in the same manner as the general pneumatic tire, and the tread 10 is provided in such a manner as to be connected to an outer end in the tire radial direction of each of the side walls. Further, a carcass extending like a toroidal shape is provided between a pair of beads, and a reinforcing member such as a belt reinforcing the carcass is buried in the tread 10, however, an illustration of them is omitted.

A plurality of main grooves extending in a tire circumferential direction are formed in the tread 10, and four main grooves 11 to 14 are formed in the present embodiment. The tread 10 is sectioned into a plurality of land portions including shoulder land portions 20 by a plurality of main grooves. The shoulder land portion 20 is positioned between each of tread ends TE and respective one of the shoulder main grooves 11 and 14 positioned in the outermost sides in the tire width direction. In the present embodiment, the shoulder land portion 20 is provided as a shoulder rib which continuously extends in the tire circumferential direction, however, is not limited to this.

In the tire T, the narrow groove 3 extending in the tire circumferential direction is formed in the shoulder land portion 20 of the tread 10. The narrow groove 3 extends continuously in a straight line shape or a zigzag shape along the tire circumferential direction. A depth D3 of the narrow groove 3 is, for example, in a range which is 0.3 to 1.5 times of a depth D1 of the shoulder main grooves 11 and 14. The narrow groove 3 is formed narrower than the shoulder main grooves 11 and 14 on a ground surface of the tread 10, and a width W1 of an opening portion of the narrow groove 3 is, for example, in a range between 0.3 and 5.0 mm. The narrow groove 3 may be provided only in the shoulder land portion 20 in one side, however, is preferably provided in the shoulder land portions 20 in both sides for achieving an excellent irregular wear resistance.

The shoulder land portion 20 is sectioned into a main land portion 21 in a tread center TC side, anda sacrificed landportion 22 in a tread end TE side by the narrow groove 3. In the present embodiment, the main land portion 21 is provided as a main rib which extends continuously in the tire circumferential direction, and the sacrificed land portion 22 is provided as a sacrificed rib which extends continuously in the tire circumferential direction. The narrow groove 3 is positioned in the vicinity portion of the tread end TE of the shoulder land portion 20, and the main land portion 21 is provided wider than the sacrificed land portion 22.

As shown in FIG. 2 in an enlarged manner, a groove bottom portion of the narrow groove 3 is formed by depressing a groove wall in the tread center TC side. More specifically, an inside concave curved surface 31 obtained by depressing the groove wall in the tread center TC side is formed in the groove bottom portion of the narrow groove 3. The inside concave curved surface 31 extends annularly along the tire circumferential direction. A contour of the inside concave curved surface 31 in a tire meridian cross section is formed by a flection surface which is depressed to an inner side in the tire width direction and has a circular arc shape. The groove bottom portion of the narrow groove 3 is formed into a shape which is wider than the opening portion of the narrow groove 3 and is rounded, and the maximum width W2 of the groove bottom portion is greater than the width W1 of the opening portion. In the light of the improvement of the mold releasing performance at the cure molding time, the width W2 is preferably equal to or less than twofold of the width W1.

In this tire, since the groove bottom portion of the narrow groove 3 is formed by depressing the groove wall in the tread center TC side, the ground pressure of the tread end side edge 21E of the main land portion 21 decreases. As a result, it is possible to suppress the local irregular wear by uniformizing the ground pressure of the main land portion 21, and the tire is excellent in the irregular wear resistance. In the light of the suitable reduction of the ground pressure of the tread end side edge 21E, a depression width of the groove bottom portion on the basis of the groove wall of the narrow groove 3 in the tread center TC side is preferably at least 1 mm. The depression width can be determined as a difference (W2−W1) between the width W1 and the width W2 in the present embodiment.

The groove bottom portion of the narrow groove 3 may be formed by depressing the groove walls in both sides including the tread end TE side in addition to the tread center TC side. However, in the case that the groove bottom portion of the narrow groove 3 is formed by depressing only the groove wall in the tread center TC side such as the present embodiment, a rigidity of the sacrificed land portion 22 is not lowered by the groove bottom portion of the narrow groove 3. As a result, an excellent tear resistance can be achieved. The tear indicates a phenomenon that the sacrificed land portion is scattered so as to be torn.

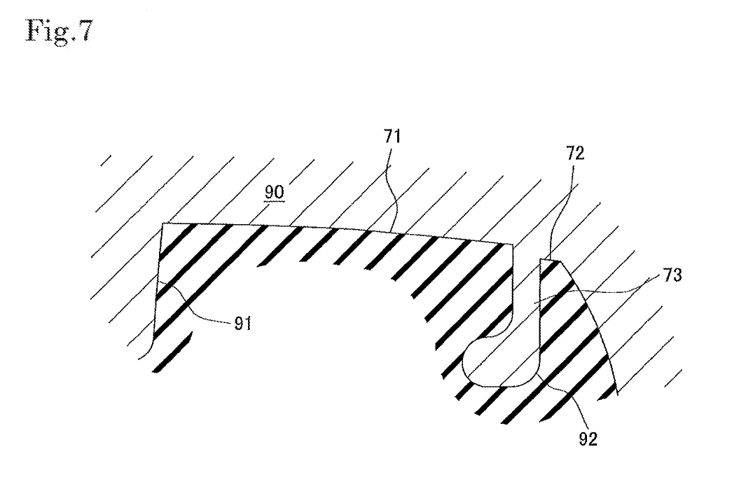

In the tire T, a plurality of dimples 4 are provided between the groove bottom portion of the narrow groove 3 and the tread end side edge 21E of the main land portion 21, the dimples 4 being obtained by depressing the groove wall of the narrow groove 3 in the tread center TC side. As a result, a resistance for pulling the blade (refer to the blade 92 in FIG. 7) which is provided in the metal mold used for cure molding of the tire T becomes small, an excellent mold releasing performance can be obtained at the cure molding time. The dimples 4 are formed by protruding portions (not shown) which are provided in a side surface of the blade. A shape of each of the dimples 4 is preferably rounded as a whole, and each of the dimples 4 is formed into a semicircular shape in the tire meridian cross section.

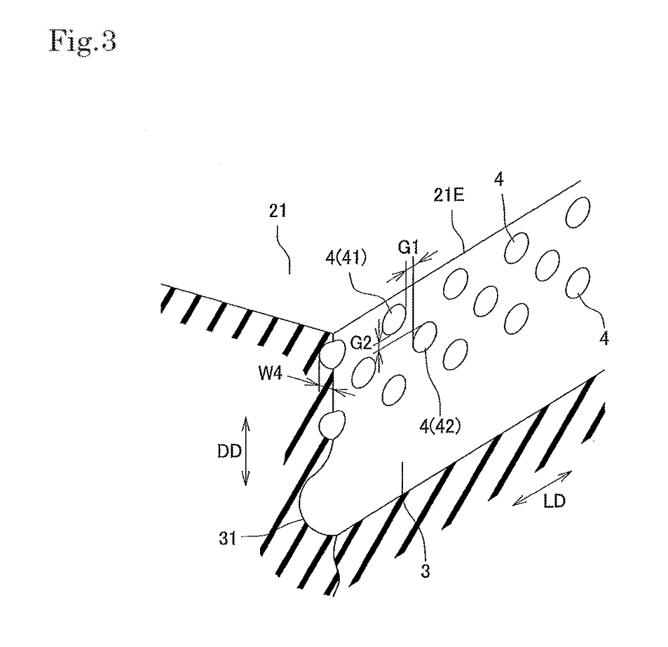

As shown in FIG. 3, in the present embodiment, the plurality of dimples 4 are arranged in a zigzag manner along a length direction LD of the narrow groove 3. In FIG. 3, the length direction LD of the narrow groove 3 corresponds to the tire circumferential direction. According to the structure mentioned above, since the leading end portion of the blade does not catch on the dimples 4 along the tire circumferential direction at the mold releasing time, an excellent mold releasing performance can be achieved. In the light of the prevention of the rubber chip between the dimples due to the blade pulling, a depression width W4 of each of the dimples 4 on the basis of the groove wall of the narrow groove 3 in the tread center TC side is preferably smaller than the depression width (W2−W1) of the groove bottom portion of the narrow groove 3.

In the present embodiment, each of the dimples 4 and each of the different dimples 4 in the nearest position are arranged so as not to overlap each other as seen from a depth direction DD of the narrow groove 3. Therefore, for example, the dimple 41 and the dimple 42 which is positioned nearest the dimple 41 are arranged at a distance G1 in the length direction LD. As a result, it is possible to suppress the rigidity reduction of the groove wall which is provided with the dimples 4 and to prevent the rubber chip between the dimples 4 due to the blade pulling. The distance G1 is, for example, between 0 and 3 mm.

In the present embodiment, each of the dimples 4 and each of the different dimples 4 in the nearest position are arranged so as not to overlap each other as seen from the length direction LD of the narrow groove 3. Therefore, for example, the dimple 41 and the dimple 42 which is positioned nearest the dimple 41 are arranged at a distance G2 in the depth direction DD. As a result, it is possible to suppress the rigidity reduction of the groove wall which is provided with the dimples 4 and to prevent the rubber chip between the dimples 4 due to the blade pulling. The distance G2 is, for example, between 0 and 3 mm.

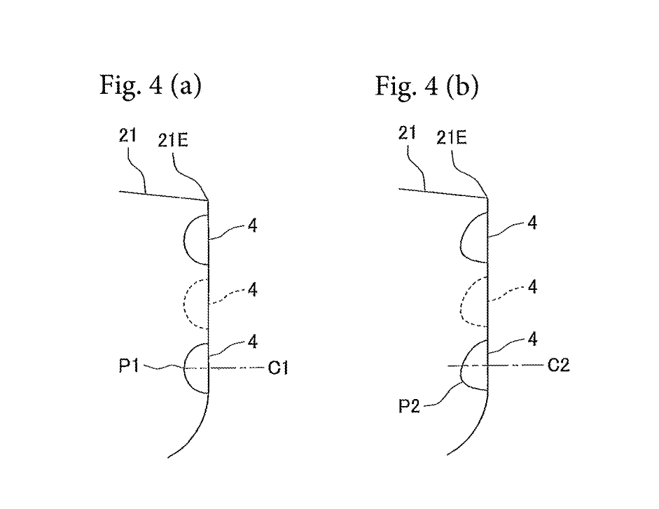

FIG. 4(a) shows a cross section of the dimples 4 and corresponds to an enlarged view of a substantial part in FIG. 2. As mentioned above, each of the dimples 4 is formed into a semicircular shape in the tire meridian cross section. The contour of each of the dimples 4 is formed by a flection surface having a circular arc shape, and a maximum depression position P1 of each of the dimples 4 is at the same height as a central transverse line C1. The maximum depression position P1 is a position which is most depressed to the tread center TC side in each of the dimples 4, and a maximum depression P2 mentioned later is based on this. The central transverse line C1 is a virtual line which passes through the center of the flection surface in the depth direction DD and extends in the tire width direction, and a central transverse line C2 mentioned later is based on this.

FIG. 4(b) shows a modified example of the dimples 4. In this example, each of the dimples 4 is formed into a semi-droplet shape (a half shape of a droplet shape) in the tire meridian cross section. A contour of each of the dimples 4 is formed by a flection surface having a circular arc shape, and the maximum depression position P2 of each of the dimples 4 exists closer to the groove bottom side than the central transverse line C2. According to the structure, since the protruding portion of the blade for forming each of the dimples 4 tends to easily come off from the groove wall, it is possible to prevent the rubber chip between the dimples 4 and the mold releasing performance is further improved.

The pneumatic tire T in which the narrow groove 3 as mentioned above is formed can be manufactured only by employing such a modification that the inner surface of the metal mold used for the cure molding is changed to the shape corresponding to the tread 10, specifically employing such a modification that the protruding portion for forming the dimples 4 as mentioned above is provided in the side surface of the blade for forming the narrow groove 3, and using the other conventional tire manufacturing steps.

The pneumatic tire according to the present invention is the same as the normal pneumatic tire except the matter that the narrow groove is formed by the shoulder land portion of the tread as mentioned above, and the conventionally known materials, shapes and structures can be all employed in the present invention.

Since the pneumatic tire according to the present invention can achieve the excellent irregular wear resistance on the basis of the actions and effects as mentioned above, the pneumatic tire can be useful for the pneumatic tire for heavy load which is used particularly to the truck and the bus.

The present invention is not limited to the embodiment mentioned above, but can be modified and changed variously within a range which does not deviate from the scope of the present invention. For example, the tread pattern can be appropriately changed in correspondence to the used intended purposes and conditions.

What is claimed is:

1. A pneumatic tire comprising a narrow groove which extends in a tire circumferential direction and is formed in a shoulder land portion of a tread, the shoulder land portion being sectioned into a main land portion in a tread center side and a sacrificed land portion in a tread end side by the narrow groove,
wherein a groove bottom portion of the narrow groove is formed by depressing a groove wall in the tread center side, and
wherein a plurality of dimples obtained by depressing the groove wall of the narrow groove in the tread center side are provided between the groove bottom portion of the narrow groove and a tread end side edge of the main land portion.

2. The pneumatic tire according to claim 1, wherein a plurality of the dimples are arranged in a zigzag manner along a length direction of the narrow groove.

3. The pneumatic tire according to claim 1, wherein each of the dimples and each of the different dimples in the nearest position are arranged so as not to overlap each other as seen from a depth direction of the narrow groove.

4. The pneumatic tire according to claim 3, wherein each of the dimples and each of the different dimples in the nearest position are arranged so as not to overlap each other as seen from a length direction of the narrow groove.

5. The pneumatic tire according to claim 1, wherein each of the dimples and each of the different dimples in the nearest position are arranged so as not to overlap each other as seen from a length direction of the narrow groove.

6. The pneumatic tire according to claim 1, wherein each of the dimples is formed into a semicircular shape in a tire meridian cross section.

7. The pneumatic tire according to claim 1, wherein each of the dimples is formed into a semi-droplet shape in a tire meridian cross section.

8. The pneumatic tire according to claim 1, wherein a depression width of each of the dimples on the basis of the groove wall of the narrow groove in the tread center side is smaller than a depression width of the groove bottom portion of the narrow groove.

9. The pneumatic tire according to claim 1, wherein the groove bottom portion of the narrow groove is formed by depressing only the groove wall in the tread center side of the groove wall in the tread center and a groove wall in the tread end side.
